(19) United States
(12) Patent Application Publication
(10) Pub. No.: US 2017/0104216 A1
(43) Pub. Date: Apr. 13, 2017

(54) ELECTROCHEMICAL DEVICE

(71) Applicant: Taiyo Yuden Co., Ltd., Tokyo (JP)

(72) Inventors: Takatoshi NAGASE, Tokyo (JP); Shinji ISHll, Tokyo (JP); Koji KANO, Tokyo (JP); Katsunori YOKOSHIMA, Tokyo (JP); Hiroki TAKAHASHI, Tokyo (JP); Yuki KAWAI, Tokyo (JP); Takahiro NAGASHIMA, Tokyo (JP)

(21) Appl. No.: 15/250,058

(22) Filed: Aug. 29, 2016

(30) Foreign Application Priority Data
Oct. 7, 2015 (JP) 2015-199483

(51) Int. Cl. H01M 4/62; H01M 10/04; H01M 4/583

(52) U.S. Cl. CPC H01M 4/625; H01M 4/583; H01M 4/622; H01M 10/0431

(57) ABSTRACT

One object is to provide an electrochemical device having a small inner resistance and a high reliability in a high temperature and a high voltage. In accordance with one aspect, the electrochemical device of the present invention includes a positive electrode and a negative electrode. At least one of the positive electrode and the negative electrode includes a current collector layer and an active material layer formed on at least one surface of the current collector layer, and the active material layer includes electrode active material bodies and a mixture film formed between the electrode active material bodies, the mixture film having a thickness of 0.1 μm to 0.4 μm.

### CROSS-REFERENCE TO RELATED APPLICATIONS

This application is based on and claims the benefit of priority from Japanese Patent Application Serial No. 2015-199483 (filed on Oct. 7, 2015), the contents of which are hereby incorporated by reference in their entirety.

### TECHNICAL FIELD

The present invention relates to an electrochemical device including an electric storage element having a positive electrode and a negative electrode stacked together with a separator placed therebetween.

### BACKGROUND

There has been a demand for reducing internal resistance in an electrochemical device that causes energy loss (heating). One disclosed method for reducing inner resistance in an electrochemical device includes adding a conductive agent such as carbon black or graphite into an electrode active material (see, e.g., Japanese Patent Application Publication No. Sho 61-26209).

Other disclosed methods include embedding a conductive agent into active carbon itself serving as an electrode active material to reduce the resistance of the active carbon itself (see, e.g., Japanese Patent Application Publication No. Hei 9-306790), or include preparing composite particles composed of a binder of an electrode active agent and a conductive agent and shaping the surface of a collector to recess along the shape of the composite particles so as to enhance the contact between an electrode active material-containing sheet and the collector (see, e.g., Japanese Patent Application Publication No. 2005-340188).

Another disclosed method includes adhering a carbon-based conductive agent to an electrode active material to form composite particle structure for reducing the resistance, uniforming the electrode density, and increasing the capacity (see, e.g., Japanese Patent Application Publication No. 2006-60193).

There is still an unlimited demand for further reducing inner resistance of an electrochemical device. An electrochemical device is also required to have a high reliability in a high temperature and a high voltage.

### SUMMARY

In view of the above, one object of the present disclosure is to provide an electrochemical device having a small inner resistance and a high reliability in a high temperature and a high voltage.

To achieve the above object, an electrochemical device according to an embodiment of the present invention includes a positive electrode and a negative electrode. At least one of the positive electrode and the negative electrode includes a current collector layer and an active material layer formed on at least one surface of the current collector layer, and the active material layer includes electrode active material bodies and a mixture film formed between the electrode active material bodies, the mixture film having a thickness of 0.1 μm to 0.4 μm.

With this arrangement, the mixture film having a thickness of 0.1 μm or larger bonds together the electrode active material bodies with a sufficient strength. Further, the mixture film having a thickness of 0.4 μm or smaller increases the electric conductivity between the electrode active material bodies and reduces the inner resistance. Therefore, with the above arrangement, it is possible to provide an electrochemical device having a small inner resistance and a high reliability in a high temperature and a high voltage.

The mixture film may include a binder and a conductive assistant, and the ratio in weight of the conductive assistant to the binder may be 0.5 to 1.25.

The thickness of the mixture film can be adjusted by the ratio of a binder to a conductive assistant. When the ratio in weight of a conductive assistant to a binder is 0.5 to 1.25, the electrode active material bodies can be bonded together via the mixture film having a thickness of 0.1 μm to 0.4 μm.

The proportion of the mixture film in a region surrounded by the plurality of electrode active material bodies may be 20% to 60%.

When the proportion of the mixture film filled in a region surrounded by the plurality of electrode active material bodies is 20% to 60%, the contact area between the electrode active material bodies and the mixture film may be larger. Therefore, the bonding strength between the electrode active material bodies is increased, and thus the strength of the electrodes is increased.

The electrode active material bodies may include a plurality of first electrode active material bodies having a first particle diameter and a second electrode active material body formed in a region surrounded by the plurality of first electrode material bodies, said second electrode active material body having a second particle diameter smaller than the first particle diameter.

In this arrangement, a region surrounded by the first electrode active material bodies having the first particle diameter contains the second electrode active material body, the second electrode active material body having the second particle diameter smaller than the first particle diameter. Such an arrangement may increase the contact area between the electrode active material bodies and the mixture film, thereby increasing the strength of the electrodes and the capacity density (the electric capacity per unit volume of an electrode) and reducing the inner resistance.

The binder may include carboxymethylcellulose or styrene-butadiene rubber, and the conductive assistant may be acetylene black.

With this arrangement, it is possible to provide an electrochemical device including a mixture film containing carboxymethylcellulose or styrene-butadiene rubber as a binder and containing acetylene black as a conductive assistant so as to achieve a small inner resistance and a high reliability in a high temperature and a high voltage.

The above electrochemical device may include a separator between the positive electrode and the negative electrode, and may be immersed in an electrolytic solution and contained in a container.

The positive electrode, the negative electrode, and the separator described above may be contained in a container along with an electrolytic solution, thereby to provide an electrochemical device having a small inner resistance and a high reliability in a high temperature and a high voltage.

As described above, the present invention provides an electrochemical device having a small inner resistance and a high reliability in a high temperature and a high voltage.

### BRIEF DESCRIPTION OF THE DRAWINGS

FIG. 1 shows a perspective view of an electrochemical device according to an embodiment of the invention.

FIG. 2 shows a perspective view of an electric storage element of the electrochemical device.

FIG. 3 shows a schematic view of an electrode sheet constituting a positive electrode and a negative electrode of the electric storage element of the electrochemical device.

FIG. 4 shows an enlarged sectional view of the electric storage element of the electrochemical device.

FIG. 5 shows a schematic view of an active material layer in the electrode sheet of the electric storage element of the electrochemical device.

FIG. 6 shows a schematic view of a region surrounded by the electrode active material bodies of the electrochemical device.

FIG. 7 shows a schematic view of electrode active material bodies having two different particle diameters and contained in the active material layer according to a variation of an embodiment of the present invention.

FIG. 8 is a table showing the measurement result of the rolling strength of electrodes according to Example 1 of the present invention.

FIG. 9 is a table showing the measurement result of the inner resistance of an electrochemical device according to Example 1 of the present invention.

FIG. 10 is a table showing the result of a high voltage test of an electrochemical device according to Example 1 of the present invention.

FIG. 11 is a table showing the result of a high temperature load test of an electrochemical device according to Example 1 of the present invention.

FIG. 12 is a table showing the measurement result of the rolling strength of electrodes according to Example 2 of the present invention.

FIG. 13 is a table showing the result of a high temperature load test of an electrochemical device according to Example 2 of the present invention.

FIG. 14 is a table showing the measurement result of the rolling strength of electrodes according to Example 3 of the present invention.

FIG. 15 is a table showing the measurement result of the capacity density of an electrochemical device according to Example 3 of the present invention.

FIG. 16 is a table showing the result of a high temperature load test of an electrochemical device according to Example 3 of the present invention.

### DESCRIPTION OF EXAMPLE EMBODIMENTS

An electrochemical device according to an embodiment of the present invention will be described below with reference to the drawings.

<Structure of Electrochemical Device>

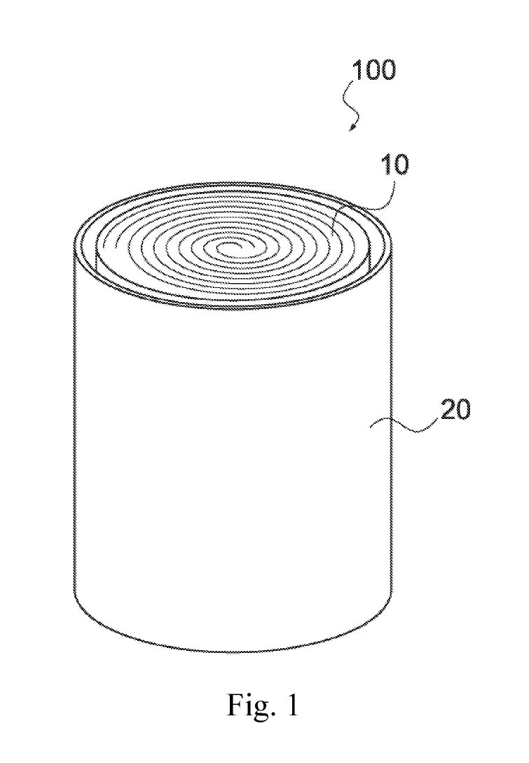

FIG. 1 shows a perspective view of an electrochemical device 100 according to an embodiment of the invention. As shown, the electrochemical device 100 may include an electric storage element 10 contained in a container 20. In FIG. 1, the lids closing the top surface and the bottom surface of the container 20 are omitted.

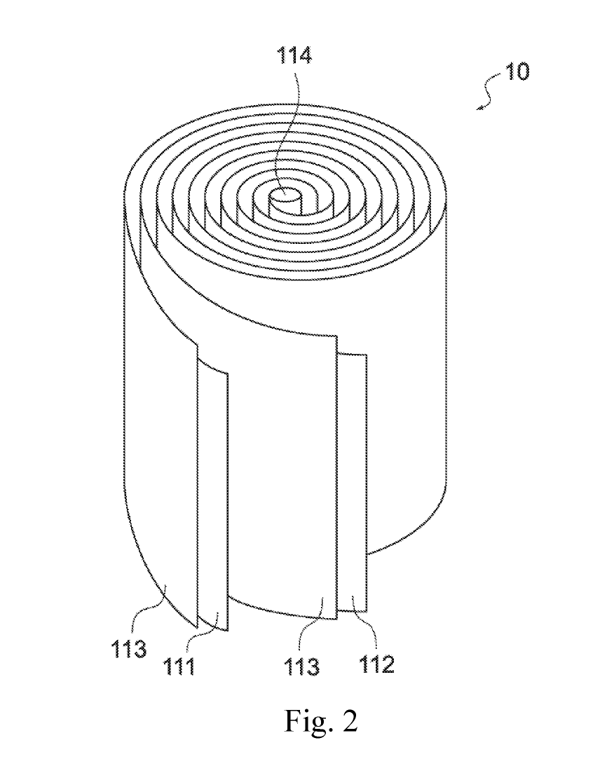

FIG. 2 is a schematic view of an electric storage element 10. As shown, the electric storage element 10 may include a positive electrode 111, a negative electrode 112, and a separator 113; and the positive electrode 111 and the negative electrode 112 may be rolled with a separator placed therebetween. Each of the positive electrode 111 and the negative electrode 112 may be constituted by an electrode sheet described below.

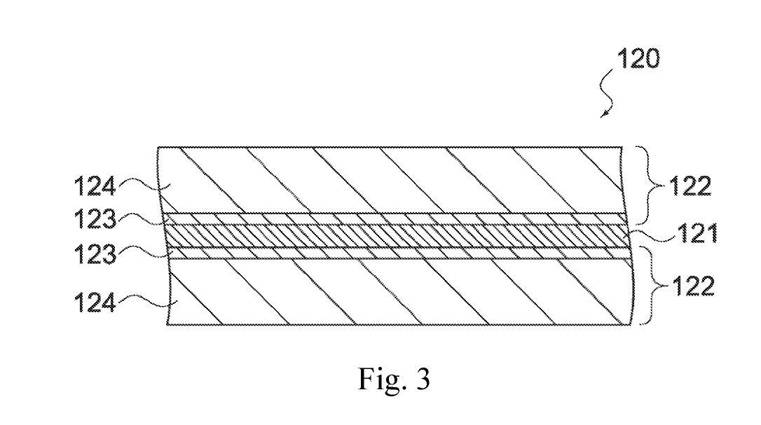

FIG. 3 is a schematic view showing the structure of the electrode sheet 120. As shown, the electrode sheet 120 may include a current collector layer 121 and electrode layers 122.

The current collector layer 121 may be composed of an electrically conductive material, for example, a metal foil such as an aluminum foil. The surface of the current collector layer 121 may be roughened chemically or mechanically, or may have through-holes. The size and shape of the current collector layer 121 may not be particularly limited For example, the current collector layer 121 may have a rectangular shape with sides of several millimeters to several tens of millimeters and a thickness of several micrometers to several tens of micrometers.

The electrode layers 122, each including an undercoat layer 123 and an active material layer 124, may be stacked on the current collector layer 121. As shown in FIG. 3, two electrode layers 122 may be stacked on both top and bottom sides of the current collector layer 121, or one electrode layer 122 may be stacked on one side of the current collector layer 121.

The undercoat layers 123 may increase the adhesiveness of the active material layers 124 to the current collector layer 121. The undercoat layers 123 may be composed of an electrically conductive material and have a thickness of about several micrometers. The undercoat layers 123 may not necessarily be provided if the adhesiveness of the active material layers 124 to the current collector layer 121 is sufficiently high.

The active material layers 124 may be stacked on the undercoat layers 123. Alternatively, the active material layers 124 may be stacked directly on the current collector layer 121. The active material layers 124 may contain electrode active material bodies and a mixture film. The configuration of the active material layers 124 will be described in more detail layer. The thickness of the active material layers 124 may not be particularly limited but may be several micrometers to several tens of micrometers.

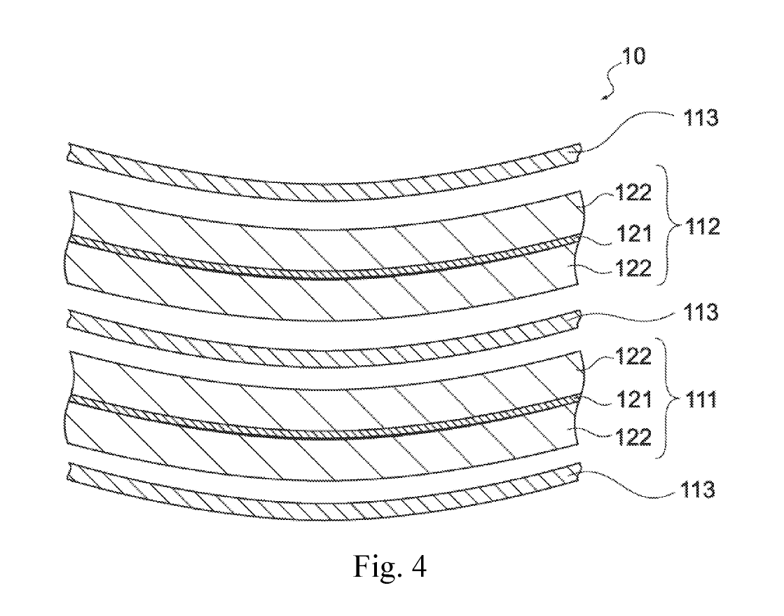

The electrode sheet 120 configured as described above may be used as the positive electrode 111 and the negative electrode 112 that are included in the electric storage element 10. FIG. 4 is an enlarged sectional view of the electric storage element 10. As shown, each of the positive electrode 111 and the negative electrode 112 may be constituted by an electrode sheet 120 composed of the current collector layer 121 and the electrode layers 122.

The positive electrode 111 and the negative electrode 112 may be stacked together with a separator 113 placed therebetween and rolled. It may also be possible that only one of the positive electrode 111 and the negative electrode 112 is constituted by the electrode sheet 120 and the other is constituted by a different electrode sheet.

The separator 113 may separate the positive electrode 111 from the negative electrode 112 and transmit ions contained in an electrolytic solution. More specifically, the separator 113 may be composed of woven fabric, unwoven fabric, a porous synthetic resin film, etc.

The electric storage element 10 may be configured as described above. The electric storage element 10 may not necessarily be rolled but may be laminated with the positive electrode 111 and the negative electrode 112, and the separator 113 placed therebetween. The numbers of layers of the positive electrodes 111 and the negative electrodes 112 may also not be particularly limited. The electric storage element 10 may include one layer of the positive electrode 111 and one layer of the negative electrode 112.

As shown in FIG. 1, the electric storage element 10 may be contained in a container 20. The container 20 may be only required to contain the electric storage element 10 along with an electrolytic solution, and thus may be, e.g., a cylindrical container made of an aluminum can. The top surface and the bottom surface of the container 20 may be closed by a lid (not shown) and may be provided with electrode terminals connected to the positive electrode 111 and the negative electrode 112, respectively.

The electrolytic solution contained in the container 20 may be an organic solvent solution including an electrolyte. Examples of the electrolyte may include SBP•BF4 (spirobipyyrolydinium tetrafluoroborate), tetraalkylammonium hexafluorophosphate, tetraalkyl phosphonium hexafluorophosphate, tetraalkylphosphonium tetrafluoroborate, and tetraalkylammonium tetrafluoroborate. One of these electrolytes may be used singly, or two or more may be used combinedly. Examples of the organic solvent may include polycarbonate, ethylmethylcarbonate, propylenecarbonate, ethylenecarbonate, y-butyrolactone, dimethylformamide, dimethylsulfoxide, acetonitrile, tetrahydrofuran, dimethoxyethane, methylformate, and styrene. One of these organic solvents may be used singly, or two or more may be used combinedly.

<Active Material Layers>

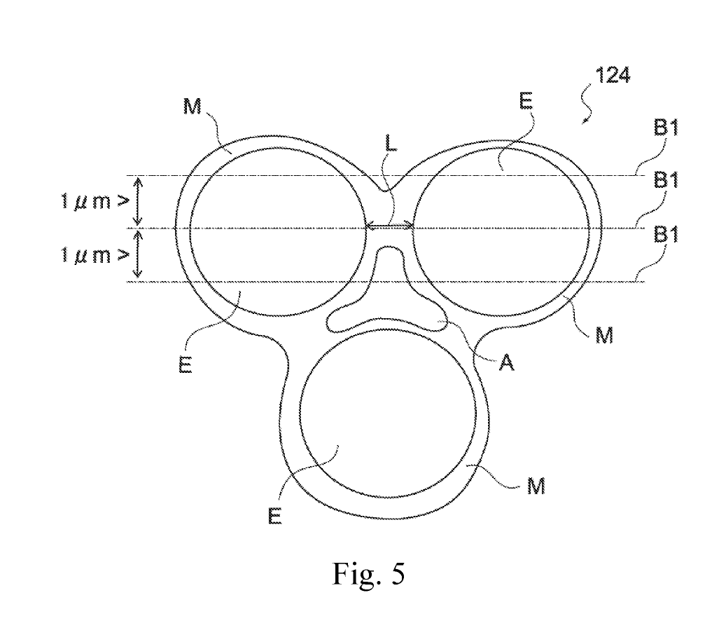

As described above, the electrode sheet 120 constituting the positive electrode 111 and the negative electrode 112 may include the active material layers 124 (see FIG. 3). FIG. 5 is a schematic view showing the structure of an active material layer 124. As shown in FIG. 5, the active material layers 124 may contain electrode active material bodies E and a mixture film M.

Examples of the electrode active material may include active carbon, polyacene, carbon whisker, and graphite in the form of powder or fiber. A desirable electrode active material is active carbon made from phenol resins, rayon, acrylonitrile resin, pitch, palm shell, etc. The electrode active material may also be a metal oxide, a metal sulfide, or a particular high molecule.

<Mixture Film>

The mixture film M may include a binder and a conductive assistant. As shown in FIG. 5, the mixture film M may be present around and between the electrode active material bodies E and bond together the electrode active material bodies.

The binder may be a synthetic resin and may retain the conductive assistant and bond together the electrode active material bodies E. Examples of the binder may include carboxymethylcellulose, styrene-butadiene rubber, polyethylene, polypropylene, polytetrafluoroethylene, polyethylene terephthalate, aromatic polyamide, cellulose, fluorine-based rubber, isoprene rubber, butadiene rubber, and ethylene-propylene rubber.

The binder may be a high molecule material such as polyvinylidene-fluoride, and a thermoplastic elastomeric high molecule material such as styrene-butadiene-styrene block copolymer, an hydrogen additive thereof, styrene-ethylene-butadiene-styrene copolymer, styrene-isoprene-styrene block copolymer, and an hydrogen additive thereof. Further, the binder may also be syndiotactic 1,2-polybutadiene, ethylene-vinyl acetate copolymer, and propylene-α-olefin (2 to 12 carbon atoms) copolymer. The materials listed above may be used either singly or combinedly to constitute the binder.

The conductive assistant may be composed of an electrically conductive material and may increase electric conductivity between the electrode active material bodies E. The conductive assistant may be, e.g., a carbon material such as graphite or carbon black. These materials may be used either singly or combinedly. The conductive assistant may also be a metal material or a conductive high molecule having electric conductivity.

The binder according to the embodiment may be composed of a material having the same characteristics with respect to oils as the conductive assistant. If, for example, the binder is composed of an oleophilic material such as styrene rubber, the conductive assistant may also be composed of an oleophilic material such as acetylene black.

Further, the binder according to the embodiment may also be composed of a material having the same characteristics with respect to water as the conductive assistant. If, for example, the binder is composed of a hydrophilic material such as water glass, the conductive assistant may also be composed of a hydrophilic material such as Ketjen black.

As described above, with a high affinity between the binder and the conductive assistant, the binder may tend to be adsorbed on the surface of the conductive assistant so as to form a mixture film including the conductive assistant and the binder mixed uniformly. This mixture film may bond between the electrode active material bodies or between the electrode active material bodies and a collector foil.

A typical binder may be PTFE (polytetrafluoroetylen), PVD (polyvinylidenedifluoride), or styrene-butadiene rubber. Depending on the type of the binder, the binder may adhere to the electrode active material bodies so as to cover the surface thereof and may inhibit ions from contacting the electrode active material bodies. The binder may also be interspersed on the surface of the electrode active material bodies and reduce the bonding strength of the electrode active material bodies. However, as described above, the high affinity between the binder and the conductive assistant may reinforce the bond between the electrode active material bodies and increase the capacity of the electric storage element 10.

<Thickness>

The thickness of the mixture film M according to the embodiment can be defined by the thickness of the mixture film M between adjacent electrode active material bodies E, as shown in FIG. 5. The thickness L of the mixture film M between the adjacent electrode active material bodies E should preferably be 0.1 μm to 0.4 μm. If the thickness L is smaller than 0.1 μm, the bonding strength between the electrode active material bodies E may be so insufficient as to cause peeling of the electrode active material bodies E. If the thickness L is larger than 0.4 μm, the conductivity between the electrode active material bodies E may be so insufficient as to increase the resistance (inner resistance) in the active material layers 124 (see Example 1).

The thickness L of the mixture film M between adjacent electrode active material bodies E may be measured as follows. First, an object sample may be cut into such a size that can be placed in a measurement apparatus, so as to expose the active material layers 124, and the exposed surface may be ground by ion milling. The ground surface may be observed by SEM (scanning electron microscope) at a magnification of 1000× to 10000× to obtain an image showing a plurality of electrode active material bodies E and the mixture film M.

A plurality of parallel straight lines B1 may be drawn along one direction of the obtained image at constant intervals of 1 μm or smaller. When one of the straight lines B1 intersects each of the outer circumferences of two electrode active material bodies neighboring each other across the mixture film Mat angles of 90°±15°, and the one straight line B1 runs through the mixture film M between the two electrode active material bodies E, the distance between the two electrode active material bodies E may be measured on the straight line B1. When a plurality of straight lines B1 intersect the same two electrode active material bodies E, the minimum one of a plurality of obtained values may be used The electrode active material bodies E interspersed in the region of the mixture film M and having a thickness smaller than that of the mixture film M may be ignored.

The mixture film M may contain a void region (region A in FIG. 5) that is omitted if the straight line B1 for measuring the distance runs across the void region A. The measurement was performed on 20 samples selected randomly from an object sample lot, and the average value was taken as the thickness L of the mixture film M for the object lot.

The active material layers 124 may be formed by applying the electrode active material and a slurry including the binder and the conductive assistant onto the current collector layer 121 (or the undercoat layers 123). The thickness of the mixture film M can be adjusted by the mixture ratio of the binder to the conductive assistant. More specifically, when the ratio in weight of the conductive assistant to the binder is 0.5 to 1.25, the thickness L may be 0.1 μm to 0.4 μm.

(Filling Ratio)

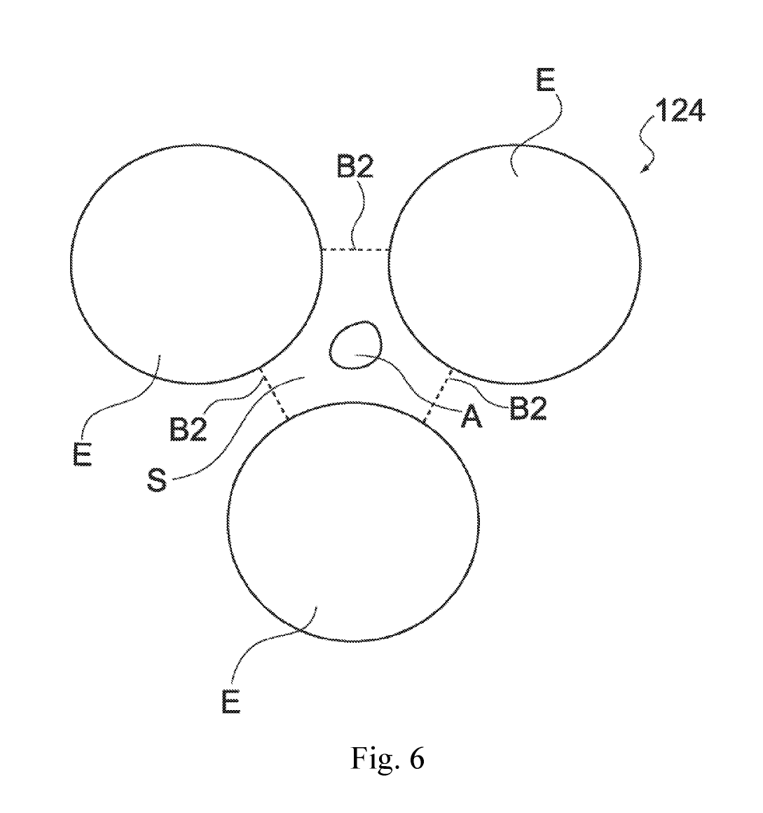

The filling ratio of the mixture film in the region surrounded by the electrode active material bodies E will now be described. FIG. 6 shows a schematic view of a region S surrounded by the electrode active material bodies E. In the drawing, the mixture film M is omitted.

As shown in FIG. 6, the region S in the SEM image showing a section of an active material layer 124 may be enclosed by lines B2 connecting between three adjacent electrode active material bodies E with the shortest distance and portions of outer circumferences of the electrode active material bodies E. The proportion in area of the mixture film M to the region S may be referred to as the filling ratio. The filling ratio may equal to (the area of the mixture film M in the region S)/(the area of the region S) and may be represented by percent.

The mixture film M may contain a void region A, and the presence of a larger void region A may reduce the filling ratio. The image obtained by SEM can be processed with an image processing software to find the area of the region S, the area of the void region A, and the area of the mixture film M in the region S. The method of preparing the samples and the method of obtaining the SEM image are as described above.

The filling ratio of the mixture film M may not be particularly limited, but may preferably be 20 to 60%. Such a filling ratio may increase the contact area between the electrode active material bodies and the mixture film M, thereby reinforcing the bonding strength between the electrode active material bodies and increase the strength of the electrodes. Further, since electrical conductivity between the electrode active material bodies E can be ensured, the resistance of the active material layer 124 can be reduced.

If the filling ratio is smaller than 20%, the bonding strength between the electrode active material bodies E may be reduced to cause peeling of the electrode active material bodies E (see Example 2). Further, if the filling ratio is larger than 60%, less electrolytic solution may reach the electrode active material bodies E (the active material layer 124 may be less impregnated with the electrolytic solution), which may reduce the electric conductivity between the electrode active material bodies E. Therefore, the electric capacity may be reduced.

<Variations>

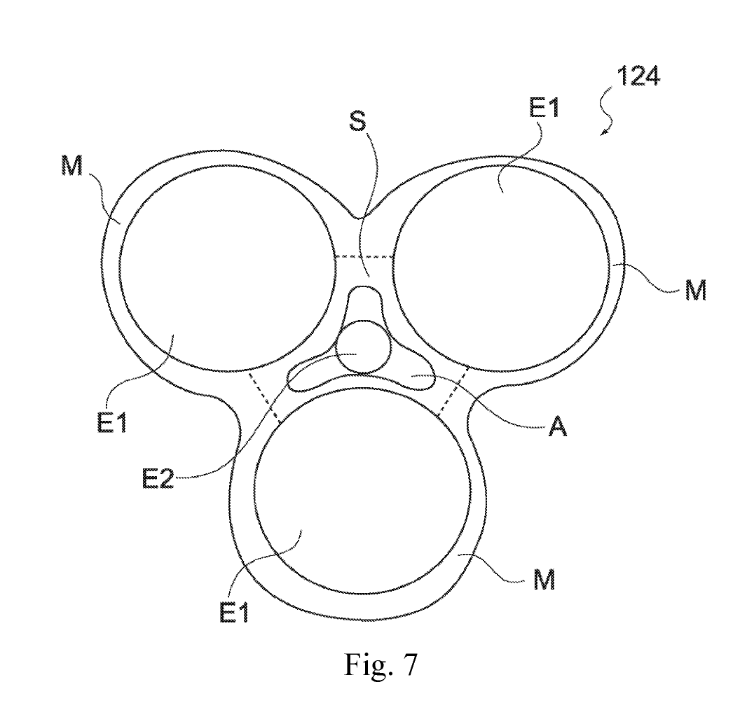

The active material layer 124 according to the embodiment may include two different electrode active materials having different particle diameters. FIG. 7 shows a schematic view of the electrode active material bodies E1 and the electrode active material body E2 included in the active material layer 124. As shown, the region S surrounded by the electrode active material bodies E1 may contain the electrode active material body E2 having a smaller particle size than the electrode active material bodies E1. Such an arrangement may increase the contact area between the electrode active material bodies and the mixture film M, thereby increasing the strength of the electrodes and the capacity density (the electric capacity per unit volume of an electrode) and reducing the inner resistance (see Example 3). The particle diameter of the electrode active material body E2 may not be particularly limited, but may preferably be one-fourth or less of the particle diameter of the electrode active material bodies E1.

### EXAMPLES

An electrochemical device according to an embodiment of the present invention was fabricated and subjected to measurements.

### Example 1

<Method of Fabricating Electrodes>

A slurry was prepared by mixing active carbon (an electrode active material), acetylene black (a conductive assistant), CMC (carboxymethyl cellulose) (a binder), and SBR (styrene butadiene rubber) (a binder). The slurry was applied onto the top and bottom surfaces of aluminum foil (a current collector layer) having a thickness of 20 μm with undercoat layers having a thickness of 5 μm placed therebetween.

Thus, an electrode including active material layers having a thickness of 70 μm was fabricated. In the embodiment, the electrodes described in the above embodiment having different thicknesses of the mixture films (composed of the conductive assistant and the binder) were fabricated by varying the amount of added SBR between 1 wt % to 10 wt % of the total weight of the electrode active material and the conductive assistant set at 100 wt %.

<Method of Fabricating Electrochemical Device>

The belt-like electrodes obtained by the above method (15 mm wide and 150 mm long) were stacked together with cellulose-based separators having a thickness of 35 μm (20 mm wide and 200 mm long) placed therebetween and rolled around a core having a diameter of 3 mm to fabricate a concentric rolled electric storage element. Lead terminals were fixed with needles on the portions of the side edges along the longitudinal direction of the electrodes where the collectors were exposed.

Next, the rolled electric storage element was fastened with a polyimide tape to retain the rolled state thereof and dried in a vacuum at 180° C. for 24 hours. After drying, the resultant rolled electric storage element was placed into an aluminum can container, and the lead terminals were connected to the container. The SBP•BF4 (spirobipyyrolydinium tetrafluoroborate) electrolytic solution (1.5 mol/L) including a mixture of styrene, polycarbonate, and EMC (ethyl methyl carbonate) as a solvent was injected into the container, and the container was sealed with rubber to complete an electrochemical device.

<Measurement of Rolling Strength of Electrodes>

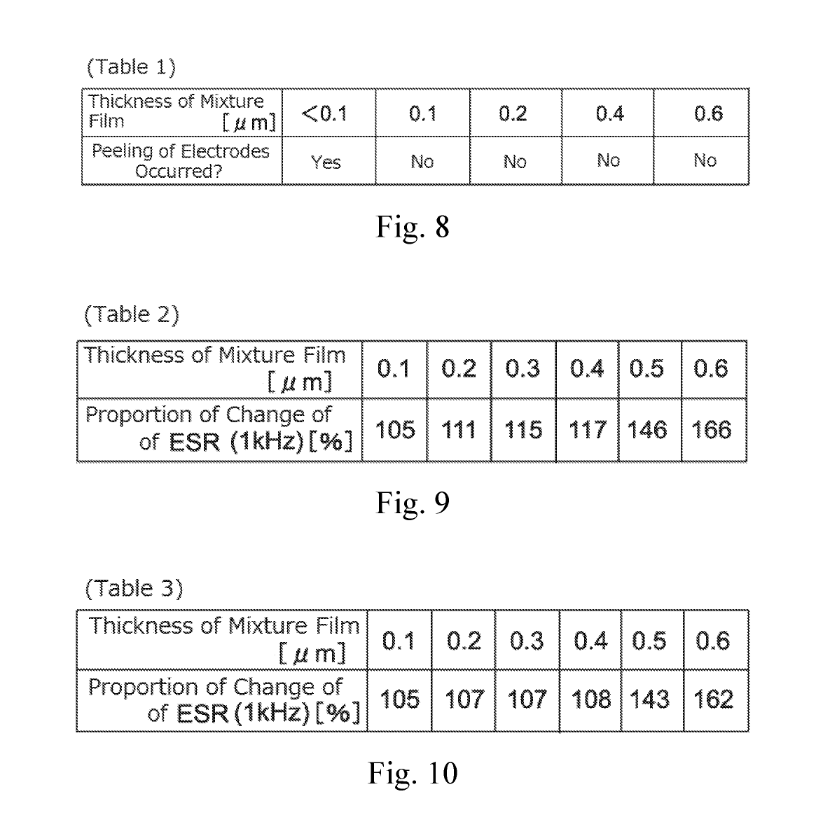

The electrodes obtained by the above method were rolled around a circular rod having a diameter of 3 mm, and the rolling strengths of the electrodes having different thicknesses of the mixture films were measured. FIG. 8 shows the result of the measurement. As shown in FIG. 8, for an electrode including a mixture film having a thickness of less than 0.1 μm, there was found fallen powder evidencing peeling of the electrode. This result confirmed that the mixture film should preferably have a thickness of 0.1 μm or larger such that the electrode active material bodies are bonded together with a sufficient strength.

<Measurement of Inner Resistance>

The electrochemical devices fabricated by the above method including electrodes having different thicknesses of mixture films were measured for the proportion of change of the inner resistance (ESR (Equivalent Series Resistance) at 1 kHz). FIG. 9 shows the result of the measurement. As shown in FIG. 9, the larger thickness of the mixture film causes a larger proportion of change of ESR and thus increases the inner resistance.

<High Voltage Test>

The electrochemical devices fabricated by the above method including electrodes having different thicknesses of mixture films were measured for the proportion of change of the inner resistance caused by application of a high voltage. The electrochemical devices were charged to 3.0 V in a room temperature for 60 min and then discharged to 0 V. The electrochemical devices were measured before and after the charging for the proportion of change of the inner resistance (the proportion of change of the ESR value).

FIG. 10 shows the result of the measurement. As shown, during charging under a high voltage, a thickness of the mixture film larger than 0.4 μm causes a large proportion of change of the inner resistance and thus increases the inner resistance. Therefore, it was confirmed that the mixture film should preferably have a thickness of 0.4 μm or smaller.

<High Temperature Load Test>

The electrochemical devices including the binder (SBR) and the conductive assistant (AB: acetylene black) at different ratios were evaluated for the high temperature load characteristics by a high temperature load test. Each of the electrochemical devices was placed in a thermostat oven at 70° C. and subjected to a voltage of 2.7 V for 500 hours to measure the proportion of retained capacity and the proportion of change of the inner resistance.

The proportion of retained capacity corresponds to the proportion of change of the capacity of the electrochemical devices measured before and after the test, and the capacity was calculated from a charging and discharging curve obtained by subjecting the electrochemical devices to CCCV (constant current constant voltage) charging at 100 mA for 30 min. and then to CC (constant current) discharging at 10 mA. The proportion of change of the inner resistance corresponds to the proportion of change of impedance of the electrochemical devices at 1 kHz measured before and after the test.

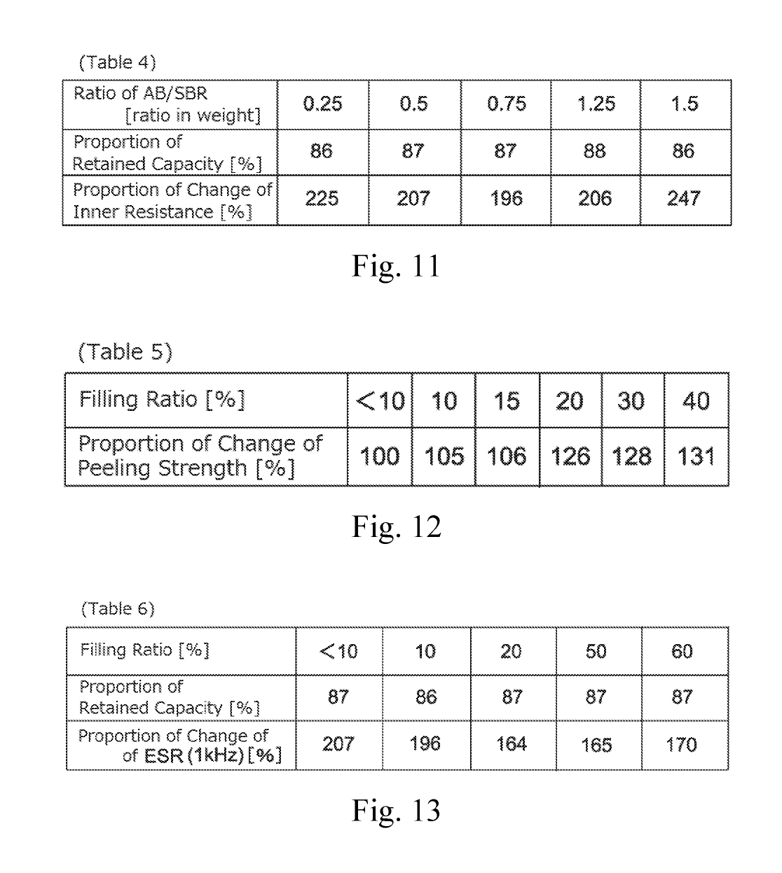

FIG. 11 shows the measurement result of the proportion of retained capacity and the proportion of change of the inner resistance. As shown, it was confirmed that increase of the inner resistance in a high temperature load test can be restricted if the ratio in weight of the conductive assistant to the binder is 0.5 to 1.25.

### Example 2

<Method of Fabricating Electrodes>

A slurry was prepared by mixing active carbon (an electrode active material), acetylene black (a conductive assistant), CMC (carboxymethyl cellulose) (a binder), and SBR (styrene butadiene rubber) (a binder). The slurry was applied onto the top and bottom surfaces of aluminum foil (a current collector layer) having a thickness of 20 μm with undercoat layers having a thickness of 5 μm placed therebetween.

In the embodiment, the electrodes described in the above embodiment having different thicknesses of the mixture films (composed of the conductive assistant and the binder) were fabricated by varying the amount of added SBR between 1 wt % to 10 wt % of the total weight of the electrode active material and the conductive assistant set at 100 wt %. The filling ratio of the mixture film in the region surrounded by the electrode active material bodies was controlled by a pressing operation after application of the slurry. In the pressing operation, pressing with a higher pressure raises the filling ratio, while pressing with a lower pressure lowers the filling ratio. Additionally, an electrode having a filling ratio of the mixture film of less than 10% was fabricated as a comparative example.

<Measurement of Rolling Strength>

The peel strengths of the electrodes having different filling ratios were investigated by a quantitative method. FIG. 12 shows the result of the measurement. The filling ratios shown in FIG. 12 are average values of the mixture film at 20 regions S selected randomly from a plurality of regions surrounded by the electrode active material bodies present in the active material layer.

As shown in FIG. 12, when the filling ratio of the mixture film is 20%, the peel strength is increased. This result confirmed that the filling ratio of 20% or higher is suitable to increase the strength of an electrode without varying the thickness of the mixture film placed between the electrode active material bodies.

<High Temperature Load Test>

An electrochemical device was fabricated using the above electrodes by the same method as for Example 1, and the proportion of retained capacity and the proportion of change of the inner resistance (the proportion of change of the ESR value) of the electrochemical device were measured. FIG. 13 shows the result of the measurement. Additionally, an electrode having a filling ratio of the mixture film of less than 10% was fabricated as a comparative example.

As shown in FIG. 13, comparison to the comparative example (<10%) confirmed that when the filling ratio is 20% or higher, increase of the inner resistance in the high temperature load characteristics can be restricted. This is because the strength of the electrodes is higher in the electrochemical device having the filling ratio of the mixture film of 20% or larger than in the electrochemical device having the filling ratio of less than 20%, and the higher strength of the electrodes restricted deterioration of the mixture film in the high temperature load test. For filling ratios larger than 60%, it was difficult to impregnate the active material layer with the electrolytic solution sufficiently within a prescribed time period in fabricating the electrochemical device. Therefore, the filling ratio should preferably be 60% or less in view of the fabricating process.

### Example 3

A slurry was prepared by mixing active carbon (an electrode active material), acetylene black (a conductive assistant), CMC (carboxymethyl cellulose) (a binder), and SBR (styrene butadiene rubber) (a binder). Two types of active carbon were used which had average particle diameters of about 8 μm and about 2 μm, respectively. The slurry was applied onto the top and bottom surfaces of aluminum foil (a current collector layer) having a thickness of 20 μm with undercoat layers having a thickness of 5 μm placed therebetween.

In the embodiment, the electrodes described in the above embodiment having different thicknesses of the mixture films (composed of the conductive assistant and the binder) were fabricated by varying the amount of added SBR between 1 wt % to 10 wt % of the total weight of the electrode active material and the conductive assistant set at 100 wt %. Additionally, an electrode including active carbon having an average diameter of about 8 μm was fabricated as a comparative example.

<Measurement of Rolling Strength>

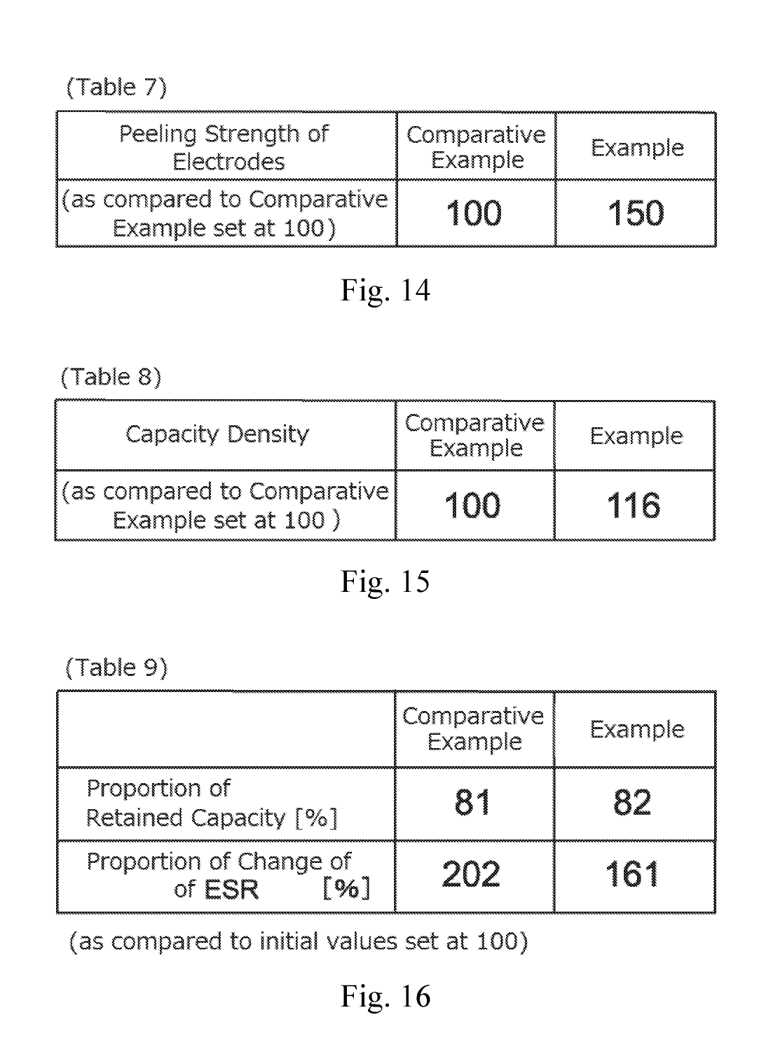

The rolling strengths of the above electrodes were evaluated based on the maximum loads applied when the electrodes are peeled in a peel test. FIG. 14 shows the result of the evaluation. As shown, the peel strength of the electrodes in Example 3 is 50% larger than that in the comparative example.

<Measurement of Capacity Density>

An electrochemical device was fabricated using the above electrodes by the same method as for Example 1, and the capacity density (the electric capacity per unit volume of an electrode) of the electrochemical device was measured. FIG. 15 shows the result of the measurement. As shown, the capacity density of the electrochemical device of Example 3 is 16% larger than that of the comparative example.

<High Temperature Load Test>

With the above electrochemical device, the proportion of retained capacity and the proportion of change of the inner resistance (the proportion of change of the ESR value) were measured by the same method as for Example 1. FIG. 16 shows the result of the measurement. As shown, increase of the inner resistance was restricted in the electrochemical device of Example 3, as compared to the comparative example.

What is claimed is:

1. An electrochemical device, comprising:
a positive electrode; and
a negative electrode,
wherein at least one of the positive electrode and the negative electrode includes a current collector layer and one or two active material layers, the one or two active material layers being formed on one or both surfaces of the current collector layer, and
wherein said one or two active material layers each include a plurality of electrode active material bodies and a mixture film formed between the plurality of electrode active material bodies, the mixture film having a thickness of 0.1 μm to 0.4 μm.

2. The electrochemical device of claim 1, wherein the mixture film includes a binder and a conductive assistant, and a ratio in weight of the conductive assistant to the binder is 0.5 to 1.25.

3. The electrochemical device of claim 1, wherein a proportion of the mixture film in a region surrounded by the plurality of electrode active material bodies is 20% to 60%.

4. The electrochemical device of claim 1, wherein the plurality of electrode active material bodies include a plurality of first electrode active material bodies having a first particle diameter and a second electrode active material body formed in a region surrounded by the plurality of first electrode material bodies, said second electrode active material body having a second particle diameter smaller than the first particle diameter.

5. The electrochemical device of claim 2, wherein the binder includes carboxymethylcellulose or styrene-butadiene rubber, and the conductive assistant is acetylene black.

6. The electrochemical device of claim 1, wherein a separator is present between the positive electrode and the negative electrode, and the electrochemical device is immersed in an electrolytic solution and contained in a container.
